(19) United States
(12) Patent Application Publication
(10) Pub. No.: US 2010/0303984 A1
(43) Pub. Date: Dec. 2, 2010

(54) Apparatus and Method for Continuous Wort Boiling

(75) Inventors: Klaus-Karl Wasmuht, Ellingen (DE); Cornelia Folz, Berlin (DE)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: KRONES AG, Neutraubling (DE)

(21) Appl. No.: 12/746,969

(22) PCT Filed: Nov. 13, 2008
(86) PCT No.: PCT/EP08/09599

§ 371 Date: Jul. 30, 2010

(30) Foreign Application Priority Data
Dec. 14, 2007 (DE) 10 2007 060 391.8

(51) Int. Cl. C12C 3/00; C12C 7/20

(52) U.S. Cl. 426/431; 99/278

(57) ABSTRACT

In order to permit continuous wort boiling during beverage brewing operations, wort is conducted over a plurality of substantially conically tapering heating surfaces arranged one above another in the manner of a cascade.

### CROSS-REFERENCE TO RELATED APPLICATION

The present application claims the benefit of priority of International Patent Application No. PCT/EP2008/009599, filed Nov. 13, 2008, which application claims priority of German Application No. 102007060391.8, filed Dec. 14, 2007. The entire text of the priority application is incorporated herein by reference in its entirety.

### FIELD OF THE DISCLOSURE

The disclosure relates to a device or a method for continuous wort boiling, such as used in beverage brewing operations.

### BACKGROUND

Up to now, the brewhouse process for the manufacture is performed in a so-called “batch process”. Approximately up to 14 brews can be achieved per day. This method generates high energy peaks and thereby requires the provision of great supply capacities. Due to set-up times between the individual production stages, the efficiency of the installations is restricted. Altogether, the batch operation results in high investment costs of the installations as well as of the building services.

Up to now, in wort boiling one complete brew each has been supplied to the wort copper for boiling. After boiling, the complete brew has been conducted out of the wort copper. After a set-up time of 30 to 60 min., the next brew could then be supplied to the wort copper.

### SUMMARY OF THE DISCLOSURE

Starting from this situation, one aspect underlying the present disclosure is to provide an improved device and an improved method for wort boiling, which are easy to realize and permit continuous wort boiling.

Here, continuous means that, different to prior art, the method is not interrupted after one batch has been treated. Over a long period which exceeds the duration of a corresponding conventional method in batch operation many times over, a certain mass flow is supplied and simultaneously discharged during wort boiling according to the present disclosure. The wort boiling process can accordingly be performed at an essentially constant process amount per time. As the set-up times between the batches are eliminated, a better utilization of the installation and thus higher efficiency are achieved.

It is advantageous for the pressure in the device to be adjustable. This ensures optimum process management.

As the heating surfaces substantially conically taper and are arranged one upon the other, a large heating area relative to a housing diameter can be ensured, so that the wort flow can be provided with sufficient energy.

Substantially conically tapering means that the surface tapers starting from a surrounding basic edge upwards or downwards. The surrounding basic edge does not have to be circular; it can rather also have a polygonal shape.

The wort can then be conducted from one heating surface to the heating surface disposed thereunder via the corresponding guide means, until it is finally discharged via a wort drain, for example for hot break separation. By the wort running through the tower from the top to the bottom it is ensured that each particle of the wort is subjected to the same thermal requirements of a boiling process—in terms of time as well as quantity. Thus, a gentler method which in turn results in a better wort quality is in particular achieved. Furthermore, the process time can be clearly reduced compared to conventional wort boiling.

Advantageously, at least two heating surfaces are arranged one upon the other. Up to twenty heating surfaces can be arranged one upon the other. It is possible for the guide means to be also heatable. The guide means can then also be embodied, for example, as conically tapering surface, so that the space in the device can be effectively utilized.

It is also possible to provide a wort boiling system in which at least two devices according to the disclosure are connected in series. By the connection of several devices in series, the structural height of the individual devices can be reduced. Moreover, the connection of the devices according to the disclosure in series results in a prolonged wort boiling process, if this is desired. Different phases of wort boiling, such as heating, boiling and stripping (evaporating undesired flavors), can be also performed in several devices.

It is also possible to provide an additional heating means, e.g. a plate heat exchanger, upstream of the device for continuous wort boiling, which heats the wort before it is conducted over the heating surfaces arranged one above the other in the manner of a cascade. This results in a particularly efficient and quick wort boiling process.

It is also possible that a tank is inserted or arranged downstream after the device for continuous wort boiling, for example a stratified storage into which the wort is continuously conducted and from which it is continuously removed. By the residence time in the tank, the temperature of the boiled wort can be continued to be maintained at an elevated level, so that processes, for example the dissolution and conversion of hop components, the formation and precipitation of protein-tannin compounds, etc. can be continued.

In the method according to the disclosure, the wort is continuously conducted over several substantially conically tapering heating surfaces arranged one above another in the manner of a cascade and heated. Therefore, the wort can be conducted over the heating surfaces across a large surface, altogether leading to a simple overall wort boiling process in terms of construction and process. It can be advantageous for the wort to be brought to different temperatures at different heating surfaces, so that, for example, a heating phase and a boiling phase can be performed in one device.

It is possible to bring the wort at the heating surfaces at normal pressure in the device to atmospheric boiling temperatures of 97-100° C., at a vacuum to a temperature of 88-92° C., and at overpressure to temperatures of up to 110° C.

Advantageously, however, before the wort is conducted over the heating surfaces, it can be heated to a temperature of 72-99° C. by a separate wort heating means, resulting in a particularly effective process.

According to a preferred embodiment, an isomerized hop product and/or a conventional hop product is supplied to the wort during the boiling process. In case of an isomerized hop product, the boiling time can be clearly reduced.

The discharged wort can be either continuously forwarded to hot break separation, or else it can be continuously conducted to at least one further device with several heating surfaces arranged one above the other in the manner of a cascade and e.g. only then be conducted to hot break separation.

According to the present disclosure, it is possible for the temperature of the heating medium to be at most 104-120° C. By this, energy peaks can be avoided and the wort can be treated in a particularly gentle way.

### BRIEF DESCRIPTION OF THE DRAWINGS

The disclosure will be illustrated below with reference to the following figures:

FIG. 1 roughly schematically shows a section through a device for wort boiling according to the disclosure.

FIG. 2 roughly schematically shows a section through a heating surface and a guide means according to one embodiment.

FIG. 3 roughly schematically shows a section through a heating surface and a guide means according to a further embodiment.

FIG. 4 roughly schematically shows a wort boiling system with several devices for boiling wort connected in series.

FIG. 5 roughly schematically shows a wort boiling system with an additional heating means and a tank.

### DETAILED DESCRIPTION OF THE PREFERRED EMBODIMENT

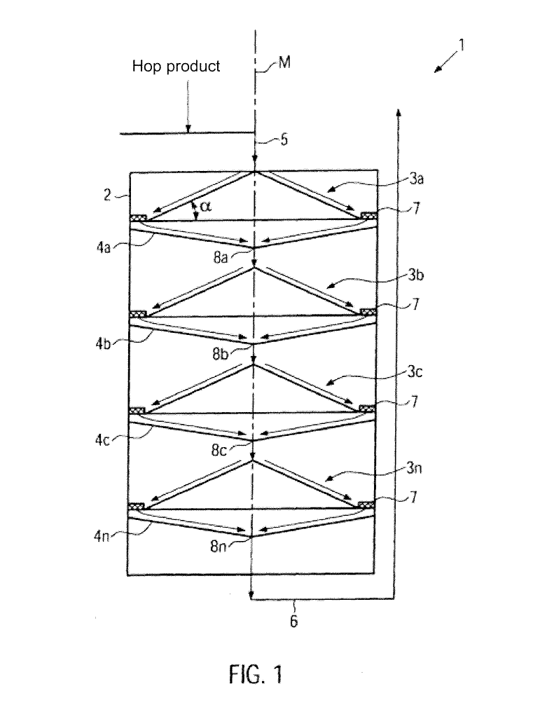

FIG. 1 roughly schematically shows a section through a device for wort boiling according to the disclosure. The device comprises an inlet 5 for lauter wort to which preferably an isomerized hop product, e.g. an extract, and/or a common hop product are supplied. In the housing 2, which preferably has a hollow cylindrical design, there are located heating surfaces 3a to 3n arranged one above another in the manner of a cascade. Here, the heating surfaces are embodied as conically tapering conical surfaces the points of which face upwards. To heat the heating surfaces 3, these can be embodied as double-walled shield through the interior of which e.g. hot steam or a heat transfer medium, e.g. water or high pressure hot water, can be conducted. For this, the heating surface can comprise a corresponding non-depicted inlet and outlet for the heat transfer medium. The different heating surfaces 3a to 3n arranged one above the other can be either connected to a common heating circuit or else be heatable to different temperatures or pressures, respectively. Then, different phases of wort boiling can be performed in one device, such as heating, boiling with or without stripping.

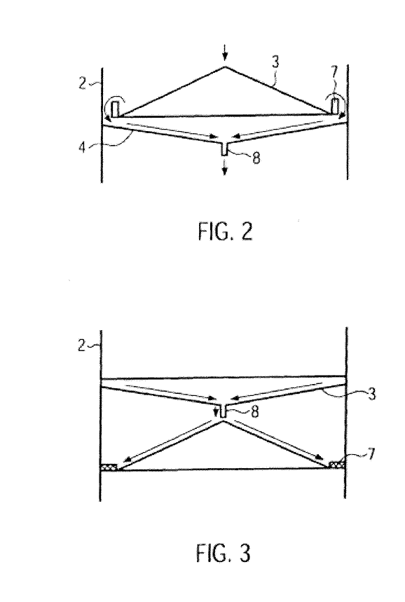

In this embodiment, a buffer region 7 is arranged in the lower region of each heating surface 3, which is here embodied as surrounding chute. The wort can then be conducted, as represented by the arrows, from this buffer region 7 to the next heating surface 3b located thereunder via a guide means 4. For this, for example openings can be embodied in the buffer region 7. As is represented in particular in FIG. 2, the buffer region can also be embodied as overflow over which the wort flows towards the guide means 4 when a predetermined level is reached. Here, the conducting means 4 is also embodied as surface conically tapering downwards in the center of which, for example, an opening 8 is located via which the wort is conducted directly or via a connecting pipe (not shown) to the center M of the housing 2 to the heating surface 3b located thereunder. It is possible for the guide means 4 to be also heatable to thus additionally heat the wort. In the process, the guide means 4 can be also embodied as a double-walled shield.

The angle α of the heating surface 3 with respect to a horizontal is approximately between 4 and 45 degrees. The flatter the course of the heating surface, the longer the residence time of the wort in the device.

The heating surfaces 3 as well as the guide means 4 are fixed to the housing 2 by means of non-depicted fixing elements.

In FIG. 1, the points of the conical heating surfaces 3 face upwards, so that the wort flows on the outer surface downwards, e.g. to the buffer 7. However, as can be taken from FIG. 3, it is also possible for the heating surfaces 3 to be arranged such that the point faces downwards, i.e. towards the wort drain 6, the heating surface 3 then comprising an opening in its center via which the wort then flows to the guide means 4, which is here also embodied as preferably heated conical surface and can also comprise a corresponding surrounding buffer 7. Then, the wort flows to the next heating surface 3. The heating surface shown in FIG. 3 and the guide means then alternate.

Preferably, at least two heating surfaces are arranged one above the other to ensure sufficient heat supply.

The device 1 can also comprise a non-depicted outlet for vapor.

The device furthermore comprises a wort drain 6 via which the boiled wort can be supplied, for example, to hot break separation.

The device preferably comprises a pressure tight housing 2 in which the pressure can be adjusted by corresponding non-depicted means, such as a pump, pressure gauge, valves. In this case, the pressure can be brought to a vacuum, normal pressure or overpressure. It is possible for the wort at the heating surfaces to be brought to temperatures of 97-100° C. at normal pressure in the device, at a vacuum to a temperature of 88-92° C., and at overpressure to temperatures of up to 110° C.

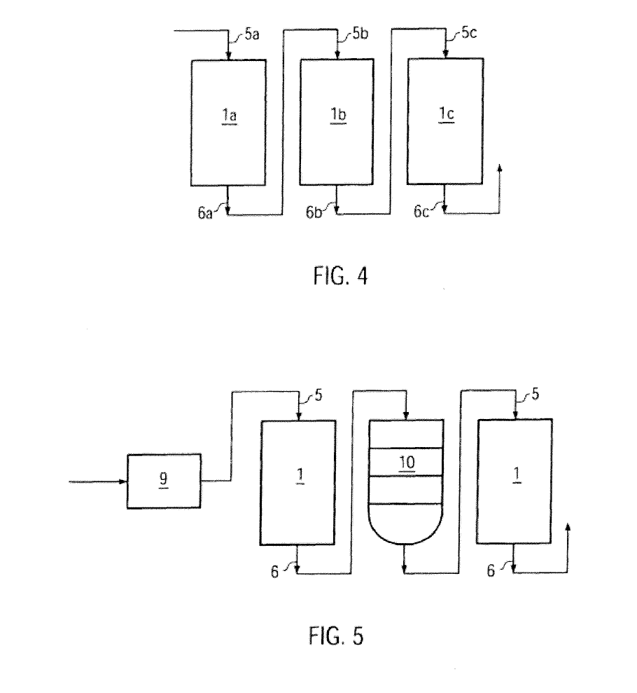

As can be taken in particular from FIG. 4, several, in this case three, devices 1a, b, c can be connected in series. In this case, the wort discharged via the outlet 6a is supplied to the wort inlet 5b of the subsequent device. Thus, the wort in the different devices can be, for example, heated to different temperatures. In a first phase in the device 1a, the wort is e.g. heated. In a further device 1b, the wort is boiled in a second phase, and in a third device 1c, flavors, for example DMS, can then evaporate in a third phase.

The temperatures to which the wort is heated depend, as described before, on the pressure in the device and are adapted to the certain phase.

It is, for example, also possible that in one device 1, the wort is conducted over the heating surfaces 3 at an elevated pressure, e.g. 2 bar, and then a release at normal pressure or vacuum takes place in a means that is arranged downstream. This means arranged downstream can then be e.g. again a device 1 with heating surfaces arranged one above the other in the manner of a cascade.

Though it is not shown, several devices can also be arranged in parallel.

FIG. 5 shows another embodiment according to the present disclosure. Here, the wort boiling system comprises a wort heating 9 which is provided for continuously heating the wort to approximately 72-99° C. Such a means can be realized, for example, by a plate heat exchanger. Subsequently, the wort is continuously supplied to a first device 1 for continuous wort boiling which comprises several substantially conically tapering heating surfaces arranged one above the other in the manner of a cascade. Heat is still supplied to the wort by the heating surfaces 3. Via the wort drain 6, the wort is here continuously supplied to a tank 10 which is here realized in the form of a stratified storage. The residence time in this stratified storage is approximately 15 to 30, preferably 20 minutes. At the bottom end of the stratified storage, the wort is discharged and can be again fed to a device 1 with substantially conically tapering heating surfaces 3 arranged one above the other in the manner of a cascade, so that the wort is set in motion, so that wort ingredients, such as protein and tannin compounds, can precipitate and undesired flavors evaporate. The finished boiled wort can then be conducted to a means for hot break separation.

That means, according to the method according to the disclosure, the wort is continuously supplied to the device 1 for wort boiling and continuously conducted over the heating surfaces, where the wort simultaneously exits continuously from the means 1 via the outlet 6.

Due to the large heating surfaces, the heating temperature of the heat transfer medium can be reduced to 104-120° C., compared to conventional wort boiling. Due to the fact that heat is continuously supplied to the means for wort boiling, peaks as they occur in conventional wort coppers can be avoided. Moreover, the set-up time is eliminated, so that the process time can be optimized. The use of isomerized hop extract is particularly advantageous, as here the boiling time can be considerably reduced.

1. Device (1) for continuous wort boiling, comprising:
a wort inlet,
several substantially conically tapering heating surfaces arranged one above the other in the manner of a cascade,
several conducting means which conduct the wort from one heating surface to the one situated thereunder, and
a wort drain.

2. Device according to claim 1, wherein the pressure in the device can be adjusted.

3. Device according to claim 1, wherein the guide means can be heated.

4. Device according to claim 1, wherein the guide means is embodied as substantially conically tapering surface.

5. Wort boiling system, in which at least two devices according to claim 1 are connected in series or in parallel.

6. Wort boiling system according to claim 5, wherein a wort heating means is provided upstream of the device for continuous wort boiling.

7. Wort boiling system according to claim 5, a tank is arranged downstream of the device.

8. Method for continuous wort boiling, wherein the wort is continuously conducted over several substantially conically tapering heating surfaces arranged one above another in the manner of a cascade and heated.

9. Method according to claim 8, wherein the wort at the heating surfaces at normal pressure in the device is brought to temperatures in the range of 97-100° C., at a vacuum to a temperature in the range of of 88-92° C., and at overpressure to temperatures of up to 110° C.

10. Method according to claim 8, and continuously forwarding the discharged wort to hot break separation or continuously conducting the discharged wort to at least one further device with several heating surfaces arranged one above the other in the manner of a cascade.

11. Method according to claim 8, wherein the wort is heated to a temperature in the range of 72-99° C. before it is conducted over the heating surfaces.

12. Method according to claim 8, and conducting the wort into a tank after it has been conducted over the heating surfaces.

13. Method according to claim 8, wherein one of conventional hop products, isomerized hop products, or a combination thereof are supplied to the wort.

14. Method according to claim 8, wherein the temperature of the heating medium is at most in the range of 104-120° C.
